(19) United States
(12) Patent Application Publication
(10) Pub. No.: US 2013/0220862 A1
(43) Pub. Date: Aug. 29, 2013

(54) Biodegradable Label

(71) Applicant: Alto Packaging Group, Inc., (US)

(72) Inventor: Frank Altomare, Mahwah, NJ (US)

(73) Assignee: ALTO PACKAGING GROUP, INC., Mahwah, NJ (US)

(21) Appl. No.: 13/773,801

(22) Filed: Feb. 22, 2013

Related U.S. Application Data
(60) Provisional application No. 61/602,729, filed on Feb. 24, 2012.

(51) Int. Cl. G09F 3/10; B65D 30/00

(52) U.S. Cl. CPC G09F 3/10; B65D 29/00
USPC 206/459.5; 283/81; 383/117

(57) ABSTRACT

A novel biodegradable label for use in connection with tubular biodegradable or compostable tubular bags for packing fresh produce. The label consists of paper printed with UV-cured or water based ink on one side of the label and biodegradable lamination on the other side of the label. The label is attached to the biodegradable bag by using heat of 175° C. from all of its four sides and the tubular bag is closed from its open ends by sealing the bag in between of two labels preferably by using heat.

### CLAIM OF PRIORITY

This application claims priority of U.S. provisional application No. 61/602,729 filed on Feb. 24, 2012 the contents of which is incorporated herein by reference in its entirety.

### FIELD OF INVENTION

This invention relates to a biodegradable label. More specifically the invention relates to a biodegradable label made of paper, particularly on packaging of fresh food products such as fruits and vegetables sold in compostable and biodegradable bags.

### BACKGROUND OF THE INVENTION

Due to the increased awareness of environmental matters, there is an increasing need for ecologically sustainable products. Use of biodegradable plastic as packaging material has increased during the last years. In many cases, however, a problem is created in that containers and packages of products may contain biodegradable materials but also nondegradable, environmentally harmful materials. Such containers and packages are hard to compost successfully because that would require separation of the biodegradable and nondegradable materials.

Fresh food products, such as fruits and vegetables are often sold in various kinds of bags, such as paper bags, boxes, or in plastic net bags. US patent application publication US2009/0180717 discloses one such plastic net bag, where the bag is formed from a tubular mesh body fabricated at least partially of plastic material, and the product label is heat sealed to the tubular mesh body to form a heat weld at the ends of the tubular body, thereby closing the ends of the tubular body. The state of the art is to use non-compostable thermoplastic for the label to enable the heat welding process. Thus the bag disclosed in US2009/0180717 uses non-degradable plastic as the material of the net bag as well as of the label.

European patent application publication EP1176104 discloses a plastic net bag where the label is used to close the ends of the tubular net and to form a handle for the bag. Similarly, as in the above mentioned patent application, here too the bag comprises only non-degradable thermoplastic.

US patent application publication US 2008/0317985 provides an improvement to US2009/0180717 in that the tubular plastic net bag is made of compostable mesh.

Thus, the state of the art for the bags for fresh food products such as fruits and vegetables therefore provides plastic net bags, made of biodegradable thermoplastic or of compostable plastic and the product labels necessarily have to include non-degradable thermoplastic, because the tubular net bags are closed at the ends by heat sealing and the state of the art does not know a method to adapt the currently used machinery for fully non-degradable materials. Accordingly, the bag necessarily includes either only non-degradable plastic products or a combination of non-degradable and compostable plastic products. From the environmental point of view, such solutions are not good enough because composting a product with any amount of non-degradable plastic is not successful and would require separation of the compostable and non-compostable components. There is currently not a single product nor a method to make a plastic net bag with a label attached to it where only biodegradable material would be used.

U.S. Pat. No. 7,618,694 provides a biodegradable label for in-mold forming for attachment of a surface of a biodegradable container. The label comprises a laminate film having a film comprising a biodegradable resin and a film comprising a heat sealable-biodegradable resin. The label is disposed directly on the mold cavity surface or mold surface and the label will thus be part of the wall surface of the container.

U.S. Pat. No. 5,294,283 discloses a labeling machine for net bags. This machine is capable of printing labels of various forms. U.S. Pat. No. 7,100,658 discloses a machine for manufacturing, filling and closing mesh bags. The machine is capable of manufacturing, filling and closing tubular mesh bags by heat welding a thermoplastic label at the ends of the tubular net.

Other patents, such as U.S. Pat. No. 6,449,929; U.S. Pat. No. 6,164,359 and U.S. Pat. No. 5,845,467 disclose other machines currently in use to make and label net bags for use in fresh food packaging.

Accordingly, the current state of the art uses machinery that necessarily requires heat sealing of product labels to close the tubular net bags. According to current practices and understanding the only materials usable in such machines are non-degradable thermoplastic labels. Therefore, there are currently no product labels that would be totally biodegradable and compatible for the machinery used to make the plastic tubular net bags. Nor is there a method to use fully biodegradable product labels for such tubular net bags. The instant invention provides a solution to this problem.

### SUMMARY OF THE INVENTION

The present invention provides solution for the above described problems by providing a biodegradable label for labeling tubular net bags, said label consisting of a paper layer having a lower side and an upper side, the upper side having information printed on water based ink or UV cured ink and the lower side being laminated with biodegradable plastic.

It is thus an object of the invention to provide a biodegradable label for use in connection with fresh food product packaging, especially with mesh bags.

It is another object of the invention to provide a biodegradable label for use in connection with compostable and biodegradable netting.

It is another object of the invention to provide a biodegradable label for use in connection with tubular compostable and biodegradable plastic net bags for packing fruits and vegetables.

It is yet another object of the invention to provide a fully compostable net bag for packing fruits and vegetables.

It is yet another object of the invention to provide a fully compostable or biodegradable label optimized for use with the machines used to product fruit and vegetable net bags.

Still another object of the invention is to provide an economic method to make a fully compostable plastic net bag with a label for packing fresh food products, such as fruits and vegetables.

It is a further object of the invention to provide a biodegradable net bag for packing fresh produce, said bag consisting of a tubular net made of biodegradable or compostable plastic and having two open ends, and two biodegradable labels consisting of a paper layer having a lower side, an upper side, two terminal ends and two side ends, the upper side having information printed on water based or UV cured ink and the lower side being laminated with biodegradable plastic, wherein the paper layer is made of paper having a thickness of 50 to 60 LB, and the biodegradable plastic being biodegradable polyethylene; wherein the biodegradable labels are laid on opposite sides of the tubular net and heat of 175° C. is applied along the two terminal ends and the two side ends of the labels, whereby the labels are attached to the tubular bag along the two terminal ends and the two side ends, and wherein the tubular bag is closed from its open ends by applying heat of 175° C. on the ends, thereby forming a seal having the open ends of the bag sealed between the terminal ends of the biodegradable labels.

### SHORT DESCRIPTION OF THE FIGURES

FIG. 1 shows the layers of the biodegradable label of this invention.

FIG. 2 shows the biodegradable label of this invention attached to a one side of a tubular bag.

FIG. 3 shows a longitudinal cross section of a tubular bag with biodegradable labels and a sealed bottom.

### DETAILED DESCRIPTION OF THE INVENTION

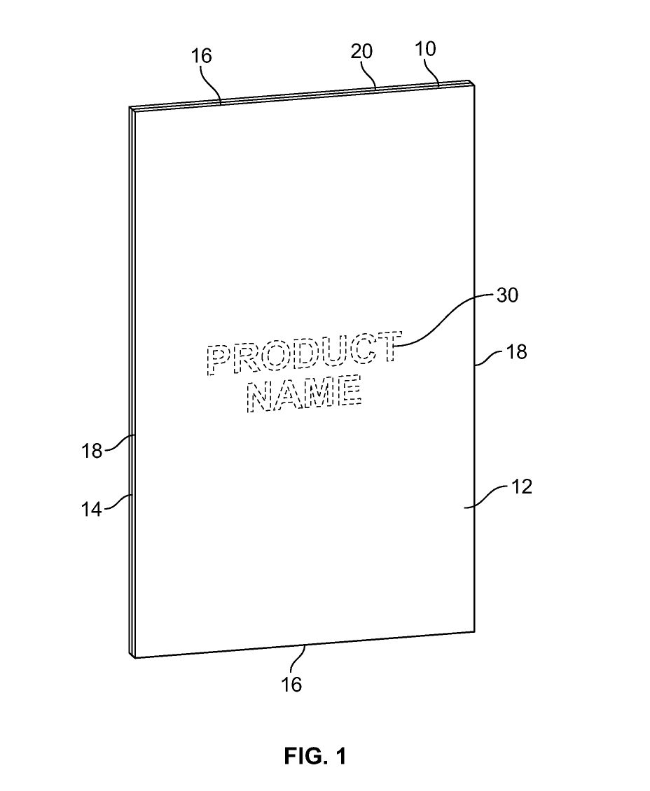

Reference will now be made in detail to presently preferred compositions, embodiments and methods of the present invention, which constitute the best modes of practicing the invention presently known to the inventor. The invention is now described in reference to the FIGS. 1-3.

A biodegradable label of the present invention comprises a paper label laminated with a biodegradable plastic film. FIG. 1 shows the layers of the label. The label comprises a paper layer 10, text printed with sustainable ink 30, and a biodegradable plastic film 20. The labels have two terminal ends 16 and two side ends 18. Paper layer 10 has a front side 12 and a back side 14 and it is laminated from the back side 14 with biodegradable plastic film 20 and the front side 12 of the paper layer has print 30 made with sustainable inks, such as UV cured ink or water based ink, whereby the printing inks do not obstruct the biodegradability of the label nor do they impact the quality of the compost.

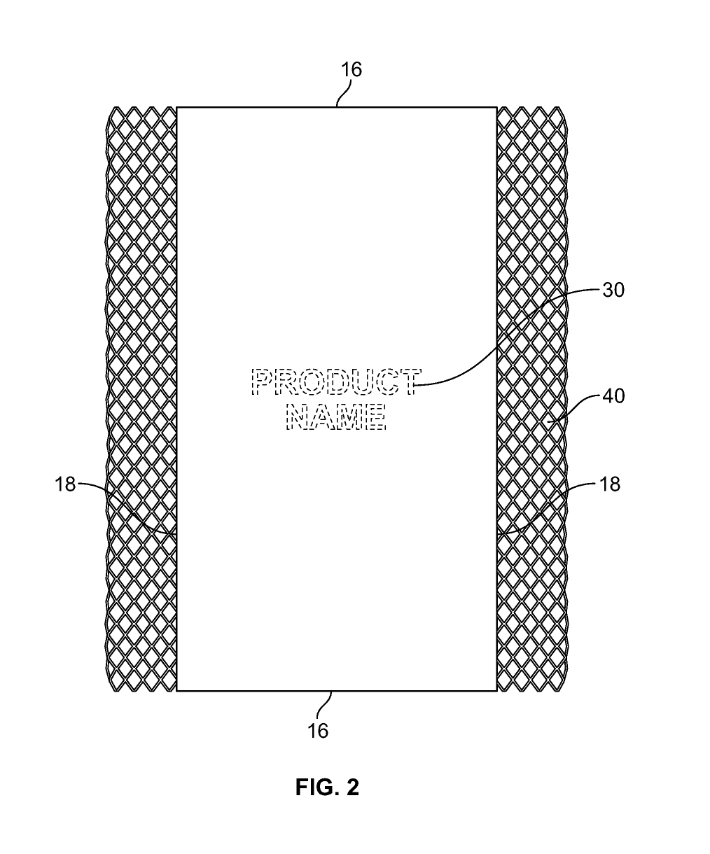

FIG. 2 shows a biodegradable label according to this invention attached on a tubular plastic bag 40. The label is attached from the two terminal ends 16 and the two side ends 18 to the tubular plastic bag 40 by using heat.

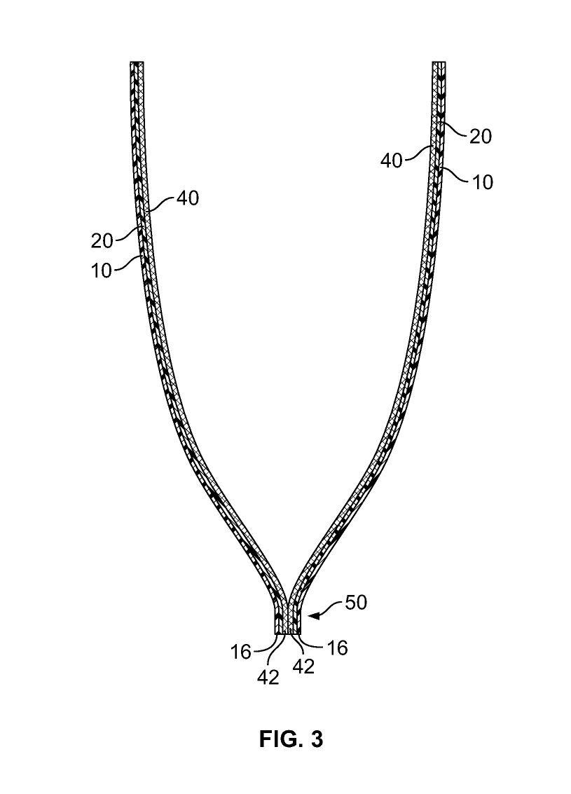

FIG. 3 shows a longitudinal cross section of a tubular plastic bag with a biodegradable label on both sides of the bag and the bottom end of the tubular bag being sealed. The seal 50 is formed by squeezing the terminal end 42 of the tubular plastic bag in between the terminal ends 16 of the label and preferably using heat to close the seal.

The paper label is preferably made of paper having a thickness between 50 and 60 LB, preferably 55 LB. The paper is preferably virgin paper, but may also be recycled paper. The preferred width of the label is between 2⅞″ to 6¾″. The paper label may contain product information, logos, advertisement or other information. Such information is provided on the paper label with sustainable inks, such as UV cured inks or water based inks. The adhesive used for the lamination is preferably biodegradable polyethylene. The adhesive may be high density polyethylene (HDPE) or low density polyethylene (LDPE) from 0.4 mil to 1 mil. In preferable embodiment 0.75 mil LDPE is used. The laminate is attached only to the back side of the paper label.

The laminate is attached to the paper with conventional lamination processes, such as adhesive lamination, solvent lamination, hot melt lamination or UV lamination. Surprisingly, a laminated label according to this invention may be attached to the mesh bag by using heat of 175° C. According to this invention, the label is attached to the bag by applying heat of 175° C. along all four sides of the laminated label to attach all the sides of the label to the bag. According to a preferred embodiment one label is attached on one side of the bag and another label is attached on the other side of the bag. The tubular bag is closed from the upper and the lower ends by sealing the ends preferably by applying heat, whereby the end seals are formed by the ends of the tubular bag squeezed between the ends of the two labels.

The existing prior art does not disclose anything similar and actually the existing prior art suggests that this approach would not even be possible. According to the existing prior art and the current practices, the only way to close the tubular mesh bag would be by heat melding a non degradable thermoplastic label over the open ends of the tubular bag. The instant invention provides a biodegradable laminated paper label that is used to close the ends of the tubular bag by using heat and additionally the biodegradable label is attached to the bag from all four sides by using heat.

The total thickness of the label is 2.5 to 4 mils (one thousands of an inch) depending on the recipe of the plastic and the thickness of the paper. According to a preferred embodiment the labels are provided in the form of continuous rolls.

The biodegradable label according to this invention is compatible with the currently known machinery for packing and labeling fresh food products in tubular net bags. The biodegradable label according to this invention is capable of making the package degradable using biodegrade components or compostable components.

What is claimed is:

1. A biodegradable label for labeling tubular net bags, said label consisting of a paper layer having a front side and an back side, the front side having information printed on water based or UV cured ink and the back side being laminated with biodegradable plastic.

2. The biodegradable label of claim 1, wherein the paper layer is made of paper having a thickness of 50 to 60 LB, and the biodegradable plastic is biodegradable polyethylene.

3. The biodegradable label of claim 2, wherein the thickness is 55 LB.

4. The label of claim 1, wherein the biodegradable polyethylene is selected from the group consisting of Low Density Polyethylene (LPDE) and High Density Polyethylene (HDPE).

5. The label of claim 4, wherein the thickness of the biodegradable polyethylene is 0.4-1.0 mils.

6. The label of claim 5, wherein the biodegradable polyethylene is LDPE.

7. The label of claim 6, wherein the thickness of the biodegradable polyethylene is 0.75 mil.

8. The biodegradable label of claim 1, wherein the labels are provided in a continuous roll.

9. The label of claim 8, wherein the label has a thickness between 2.5 to 4 mils.

10. The biodegradable label of claim 9, wherein label is 2⅞″ to 6¾″ wide.

11. A biodegradable label for labeling tubular net bags, said label consisting of a paper layer having a front side and a back said, the front side having information printed on water based or UV cured ink and the back side being laminated with biodegradable polyethylene,
said paper having a thickness of 50 to 60 LB,
said polyethylene being LPDE and having a thickness of 0.75 mils,
said label having a width of is 2⅞″ to 6¾″; and
said label being provided as a continuous roll.

12. A tubular net bag for use of packing fresh food products said bag comprising:
a tubular net made of biodegradable plastic and having two open ends, and
two biodegradable labels according to claim 1 each having two terminal ends and two side ends,
wherein the biodegradable labels are laid on opposite sides of the tubular net and heat of 175° C. is applied along the terminal ends and the side ends of the labels, whereby the labels are attached to the tubular bag along their terminal ends and the side ends, and
wherein the tubular bag is closed by forming a seal consisting of the open ends of the bag being squeezed between the terminal ends of the biodegradable label by applying heat of 175° C.

13. The biodegradable tubular net bag of claim 12, wherein the biodegradable polyethylene is selected from the group consisting of LPDE and HPDE.

14. The biodegradable net bag of claim 13, wherein the thickness of the biodegradable polyethylene is 0.4-1.0 mils.

15. The label of claim 14, wherein the biodegradable polyethylene is LDPE or HDPE.

16. The label of claim 15, wherein the thickness of the biodegradable polyethylene is 0.75 mil.

17. A biodegradable tubular net bag for packing fresh produce, said bag consisting of a tubular net made of biodegradable plastic and having two open ends, and two biodegradable labels consisting of a paper layer having a front side, a back side, two terminal ends and two side ends, the front side having information printed on water based or UV cured ink and the back side being laminated with biodegradable plastic, wherein the paper layer is made of paper having a thickness of 50 to 60 LB, and the biodegradable plastic is biodegradable polyethylene;
wherein the biodegradable labels are laid on opposite sides of the tubular net and heat of 175° C. is applied along the two terminal ends and the two side ends of the labels, whereby the labels are attached to the tubular bag along the two terminal ends and the two side ends, and
wherein the tubular bag is closed by forming a seal consisting of the open ends of the bag being squeezed between the terminal ends of the biodegradable label by applying heat of 175° C.

18. The biodegradable tubular net bag of claim 17, wherein the thickness of the paper is 55 LB.

19. The biodegradable tubular net bag of claim 18, wherein the biodegradable polyethylene is LDPE with a thickness of 0.75 mils.

20. The biodegradable net bag of claim 19, wherein the label has a width between 2⅞″ and 6¾″.
